(19) United States
(12) Patent Application Publication
(10) Pub. No.: US 2013/0318545 A1
(43) Pub. Date: Nov. 28, 2013

(54) ODD ARCHIVE APPARATUS

(71) Applicant: Hitachi-LG Data Storage, Inc., Tokyo (JP)

(72) Inventor: Hiroki YABU, Tokyo (JP)

(73) Assignee: Hitachi-LG Data Storage, Inc., Tokyo (JP)

(21) Appl. No.: 13/900,595

(22) Filed: May 23, 2013

(30) Foreign Application Priority Data
May 24, 2012 (JP) 2012-118403

(51) Int. Cl. G11B 33/04

(52) U.S. Cl. CPC G11B 33/0433
USPC 720/600

(57) ABSTRACT

It is provided an ODD archive apparatus to which a plurality of optical disk media are mounted, the ODD archive apparatus comprising: a cartridge unit accommodating the plurality of optical disk media therein; an optical disk drive for reading/writing data from/to the plurality of optical disk media; a rail assembly for carrying the plurality of optical disk media; and a chassis accommodating the cartridge unit, the optical disk drive, and the rail assembly therein. The rail assembly includes a carrying unit for holding and carrying one of the plurality of optical disk media; a rail for guiding movement of the carrying unit; and a motor for moving the carrying unit, the rail assembly having both end portions fixed to the chassis.

### CLAIM OF PRIORITY

The present application claims priority from Japanese patent application JP 2012-118403 filed on May 24, 2012, the content of which is hereby incorporated by reference into this application.

### BACKGROUND OF THE INVENTION

This invention relates to an optical disk drive (ODD) archive device to which a plurality of optical disk media are mounted, and more particularly, to a structure for fixing a rail for guiding movement of pickers.

There is known an ODD archive apparatus to which a plurality of optical disk media can be mounted. The ODD archive apparatus selectively takes out an optical disk medium mounted to a cartridge unit and mounts the taken-out optical disk medium to an optical disk drive to thereby read and write data.

Pickers, which are configured to selectively take out an optical disk medium mounted to the cartridge unit, and to move the taken-out optical disk medium to a position for mounting the optical disk medium onto the optical disk drive, are assembled to a rail, and are structured to move along the rail.

As the structure of an electric actuator using a motor as a drive source, structures described in JP 2002-46039 A and JP 2009-127742 A have been proposed.

### SUMMARY OF THE INVENTION

However, in the conventional ODD archive apparatus, the rail cannot be disassembled unless a top cover, a front panel, and a rear panel are disassembled, and it is necessary to disassemble components provided on a deep side in order to disassemble the rail, which takes time to disassemble the rail. Accordingly, a rail fixing structure allowing the rail to be easily assembled and disassembled is needed.

Further, in the conventional ODD archive apparatus, when the rail is disassembled, it is necessary to disassemble components fixed to the rail, such as a lead screw, a stepping motor, a pulley, and a timing belt. Accordingly, when fixing the rail again, the disassembled components need to be assembled. In particular, movable components such as the lead screw, the stepping motor, the pulley, and the timing belt need to be adjusted in positional relationships at the time of reassembly. Accordingly, the rail fixing structure, which is configured to allow the rail to be easily assembled and disassembled, is needed.

This invention has an object to propose a structure in which the rail can be easily disassembled and assembled, and time and effort for positional adjustment of components to be fixed to the rail can be eliminated.

The representative one of inventions disclosed in this application is outlined as follows. There is provided an ODD archive apparatus to which a plurality of optical disk media are mounted, the ODD archive apparatus comprising: a cartridge unit accommodating the plurality of optical disk media therein; an optical disk drive for reading/writing data from/to the plurality of optical disk media; a rail assembly for carrying the plurality of optical disk media; and a chassis accommodating the cartridge unit, the optical disk drive, and the rail assembly therein. The rail assembly includes a carrying unit for holding and carrying one of the plurality of optical disk media; a rail for guiding movement of the carrying unit; and a motor for moving the carrying unit, the rail assembly having both end portions fixed to the chassis.

According to an exemplary embodiment of the present invention, it is possible to easily assemble and disassemble the rail.

### BRIEF DESCRIPTION OF THE DRAWINGS

The present invention can be appreciated by the description which follows in conjunction with the following figures, wherein:

FIG. 1 is a perspective view illustrating a configuration of an ODD archive apparatus according to an embodiment of this invention;

FIG. 2 is a perspective view illustrating the rail ASSY according to the embodiment of this invention;

FIG. 3 is a perspective view illustrating a front portion of the rail ASSY according to the embodiment of this invention;

FIG. 4 is a top view of the rail ASSY according to the embodiment of this invention;

FIG. 5 is a perspective view illustrating the front portion of the rail ASSY according to the embodiment of this invention;

FIG. 6 is a cross-sectional view illustrating the rail ASSY according to the embodiment of this invention;

FIG. 7 is a perspective view illustrating a rear portion of the rail ASSY according to the embodiment of this invention;

FIG. 8 is a perspective view illustrating the rear portion of the rail ASSY according to the embodiment of this invention;

FIG. 9 is a perspective view illustrating a portion of the fan case according to the embodiment of this invention; and

FIG. 10 is a front view illustrating the rail ASSY which is fixed to the fan case according to the embodiment of this invention.

### DETAILED DESCRIPTION OF THE PREFERRED EMBODIMENT

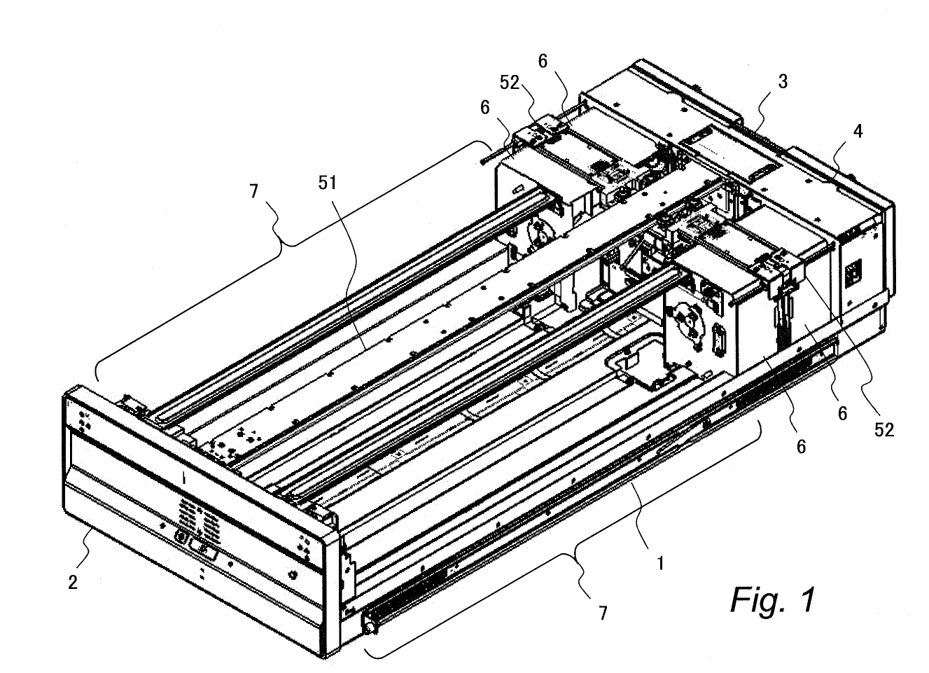

FIG. 1 is a perspective view illustrating a configuration of an ODD archive apparatus according to an embodiment of this invention, and illustrating a state in which a top cover is disassembled from the ODD archive apparatus.

As illustrated in FIG. 1, a chassis base 1 forms a bottom surface of the ODD archive apparatus. A front panel 2 is fixed to a front side of the chassis base 1 so as to be substantially upright, whereas a fan case 4 is fixed to a rear side of the chassis base 1 so as to be substantially upright. The fan case 4 accommodates a cooling fan therein, and a rear panel 3 is fixed to a rear side (outer side) of the fan case 4. In this manner, the chassis base 1, the front panel 2, the rear panel 3, and the fan case 4 form a chassis having substantially a box-like shape. Further, the rear panel 3 and the fan case 4 form a rear panel assembly (ASSY).

A rail 51 is fixed between the front panel 2 and the rear panel 3 so as to bridge between an upper portion of the front panel 2 and an upper portion of the rear panel ASSY. As described later, the rail 51 is fastened at a front end thereof to the front panel 2 with screws, and is engaged at a rear end thereof with a pin protruding from the fan case 4, to thereby extend over the chassis base 1. Right and left two pickers 52 are assembled to the rail 51 so as to be movable along the rail 51, and the rail 51 and the pickers 52 form a rail assembly (ASSY) 5.

Further, on the rear side of the chassis base, a plurality of optical disk drives 6 are fixed on both sides of the rail 51 so as to sandwich the rail 51 therebetween. It should be noted that FIG. 1 illustrates the ODD archive apparatus in which two optical disk drives 6 are placed on each of right and left sides of the rail (four optical disk drives 6 are placed in total), but the optical disk drives 6 may be placed on the ODD archive apparatus in a way other than the illustrated way.

It should be noted that a cartridge unit 7 for mounting optical disk media is formed in a space between the optical disk drives 6 and the front panel 2. Below the cartridge unit 7, there is formed a holder capable of arranging substantially upright the optical disk media that are mounted to the ODD archive apparatus. The optical disk media mounted to the ODD archive apparatus are normally held by the holder. The optical disk media are mounted to the optical disk drives 6 as needed, and data is read from and written to the optical disk media.

The pickers 52 are movable along the rail 51, and include arms that are engaged with a side surface of an optical disk medium to be mounted to the ODD archive apparatus. The pickers 52 move along the rail 51 to a position of a predetermined optical disk medium, and engage a side surface of the predetermined optical disk medium with the arms. Then, the pickers 52 take out the predetermined optical disk medium from the cartridge unit 7, and hold the predetermined optical disk medium on the pickers 52. After that, the pickers 52 move along the rail 51 to a side surface of the predetermined optical disk drive 6, carry the optical disk medium, and insert the optical disk medium held by the pickers 52 into the predetermined optical disk drive 6 through operation of the arms.

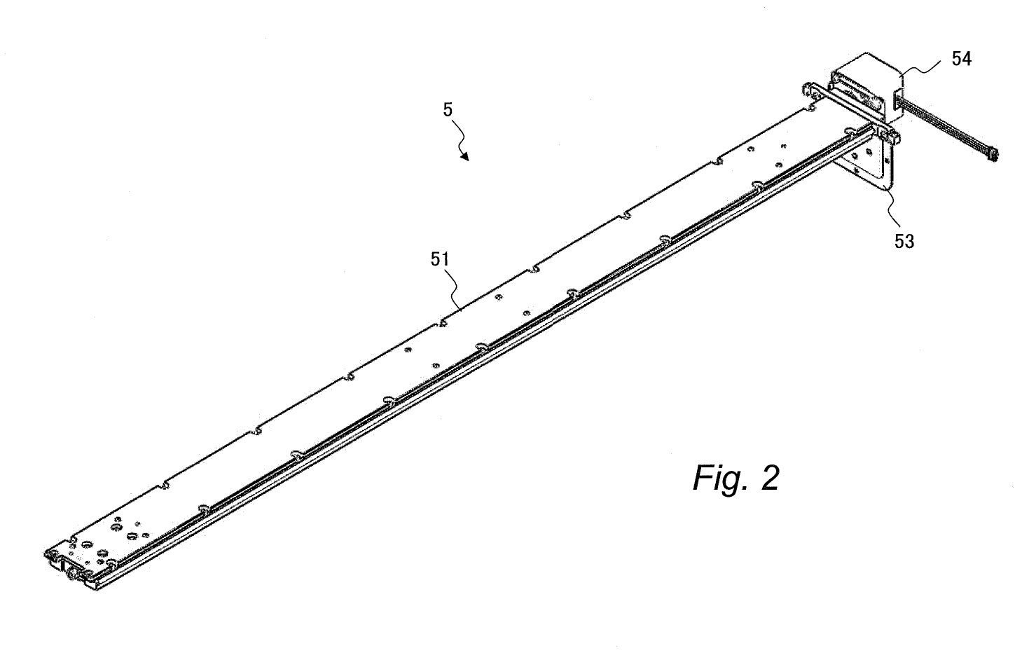

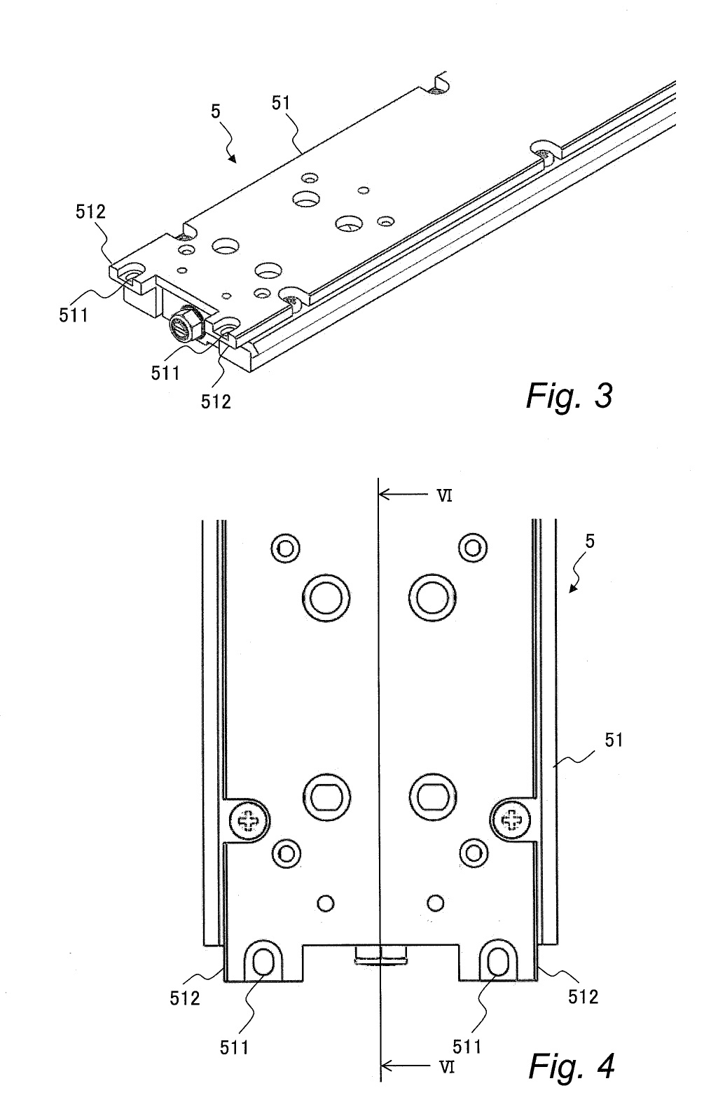

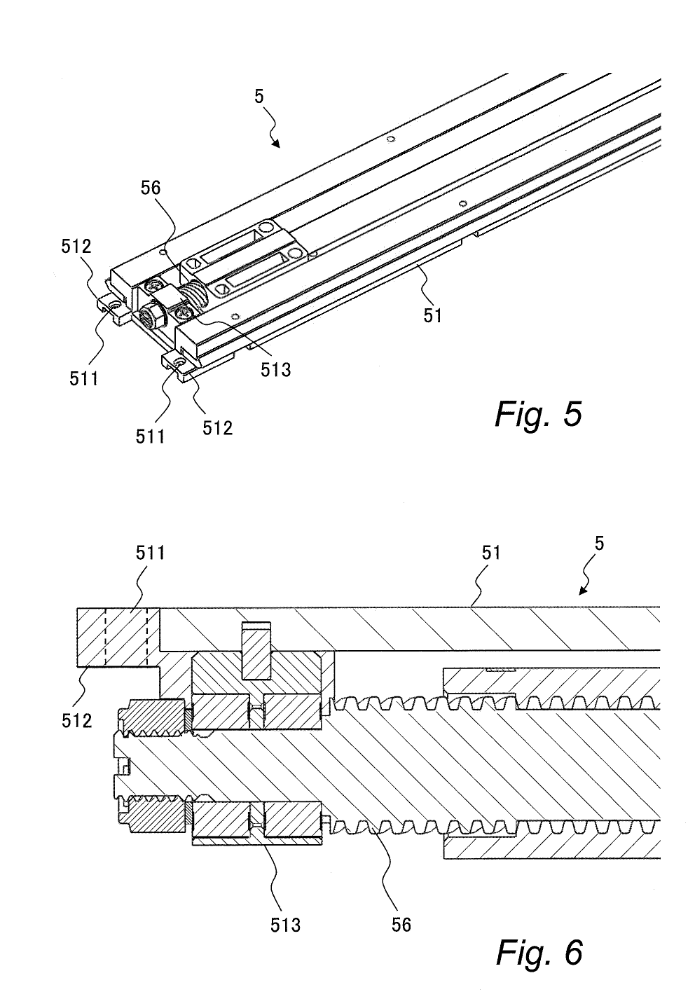

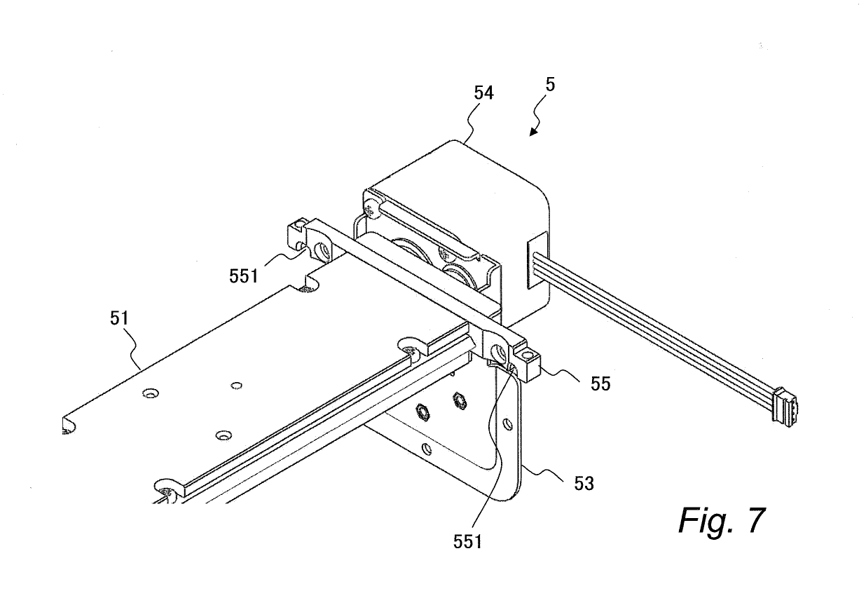

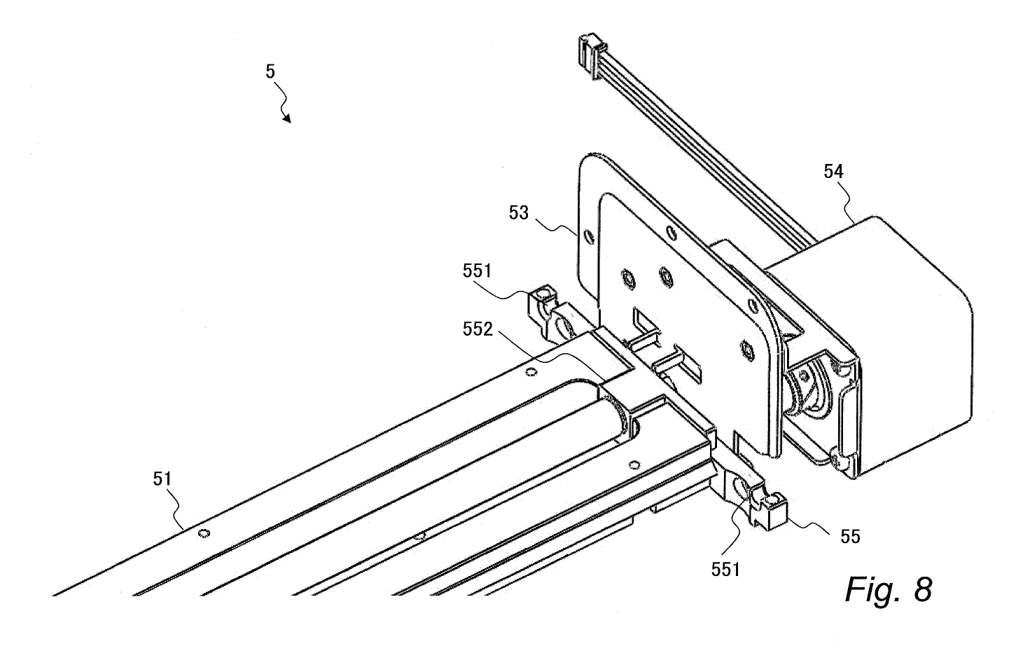

FIG. 2 is a perspective view illustrating the rail ASSY 5 according to the embodiment of this invention. FIG. 3 is a perspective view illustrating a front portion of the rail ASSY 5 viewed from a top side thereof. FIG. 4 is a top view illustrating the rail ASSY 5. FIG. 5 is a perspective view illustrating the front portion of the rail ASSY 5 viewed from a bottom side thereof. FIG. 6 is a cross-sectional view illustrating the rail ASSY 5 taken along the line VI of FIG. 4. FIG. 7 is a perspective view illustrating a rear portion of the rail ASSY 5 viewed from a top side thereof. FIG. 8 is a perspective view illustrating the rear portion of the rail ASSY 5 viewed from a bottom side thereof. It should be noted that FIGS. 2 to 8 illustrate the rail ASSY 5 in which the pickers 52 are disassembled from the rail 51.

The rail 51 includes, at the front portion thereof, screwing holes 511 for fastening the rail 51 to the front panel 2 with screws, and includes protrusions 512 to be engaged in recesses formed in the front panel 2. It should be noted that, in the rail 51 according to this embodiment, the screwing holes 511 are formed in the protrusions 512, respectively, but the screwing holes 511 may be formed in positions different from the protrusions 512.

The protrusions 512 of the rail 51 and the recesses of the front panel 2 are engaged with each other, and thus the rail 51 (namely, front end of the rail ASSY 5) and the front panel 2 are positioned.

Further, as illustrated in FIGS. 5 and 6, a recess is formed in a center portion of a bottom surface side of the rail 51, and a lead screw 56 is arranged in the recess. The pickers 52 are engaged with threads of the lead screw 56. Rotation of the lead screw 56 causes the pickers 52 to move along the rail 51.

A front end side of the lead screw 56 is held by a bearing 513, whereas a rear end side thereof is held by a bearing 552 (illustrated in FIG. 8). The bearing 513 is fitted in the recess formed in the center portion of the bottom surface side of the rail 51. Further, the bearing 552 is fixed to a bracket 55. The bracket 55 is fixed to the rail 51 so that the bearing 552 is received in a rear end of the recess formed in the center portion of the back surface side of the rail 51.

Further, as illustrated in FIGS. 7 and 8, the bracket 55 is fixed to the rear end of the rail 51. Further, a motor bracket 53 is fixed to the bracket 55, and a stepping motor 54 is fixed to the motor bracket 53 (namely, rear end of the rail 51). It should be noted that the bracket 55 and the motor bracket 53 may be formed integrally.

The motor bracket 53 is partially or entirely formed into a plate-like shape extending substantially perpendicularly to an extending direction of the rail 51.

A shaft of the stepping motor 54 is coupled to the lead screw 56. Rotation of the stepping motor 54 causes the lead screw 56 to rotate, to thereby move the pickers 52. In this embodiment, the shaft of the stepping motor 54 and the lead screw 56 are coupled to each other through the intermediation of reduction gear means such as a gear, but may be directly coupled to each other.

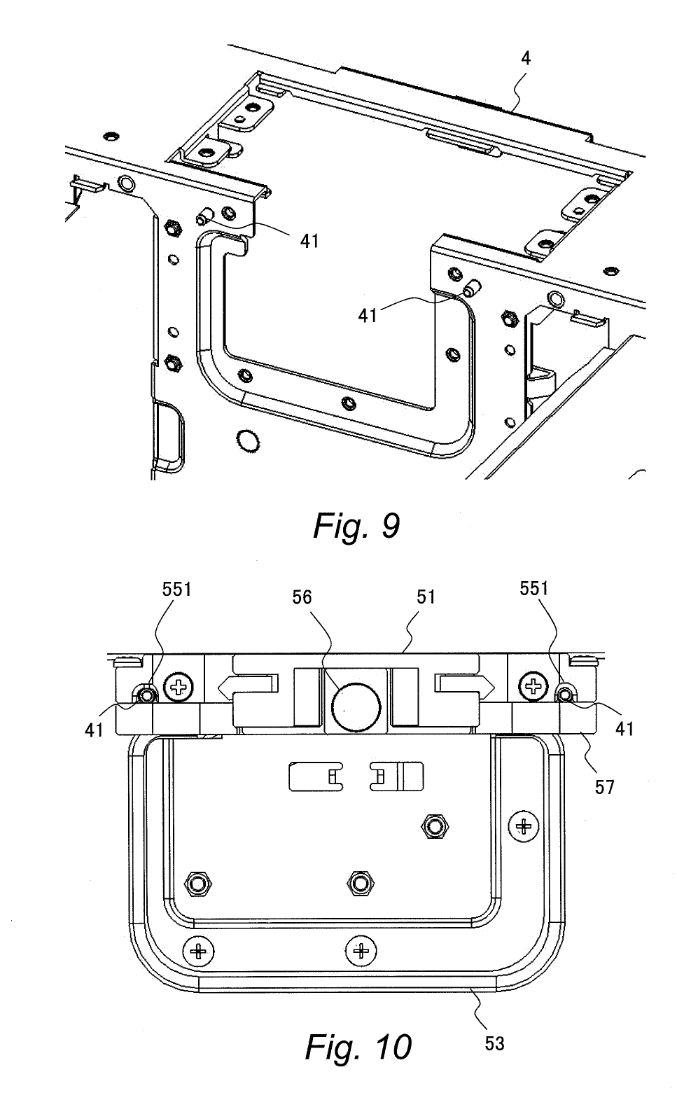

The bracket 55 has a thickness in the extending direction of the rail 51, and includes a groove 551 extending in the extending direction of the rail 51. The fan case 4 includes pins 41 protruding in the extending direction of the rail 51 (illustrated in FIG. 9), and the pins 41 are engaged in the groove 551.

FIG. 9 is a perspective view illustrating a portion of the fan case 4 according to the embodiment of this invention which is engaged with the rail ASSY 5. FIG. 10 is a front view illustrating a state viewed from a front surface side of the fan case 4, in which the rail ASSY 5 is fixed to the fan case 4.

The two pins 41 protrude from the front surface side of the fan case 4 in the extending direction of the rail 51. Under a state in which a fixing member 57 is fixed to the bracket 55 and thus the groove 551 exhibits a cylindrical shape, the groove 551 of the bracket 55 and the two pins 41 are engaged with each other. The groove 551 and the pins 41 are engaged with each other, and thus the bracket 55 (namely, rear end of the rail ASSY 5) and the fan case 4 are positioned. It should be noted that the bracket 55 and the fixing member 57 may be formed integrally.

As described above, according to the embodiment of this invention, the rear end portion of the rail ASSY 5 is engaged with the pins 41, and the rail ASSY 5 is fastened to the front panel 2 with screws through the screwing holes 511 formed in the front end portion of the rail ASSY 5. Accordingly, it is possible to easily assemble and disassemble to the rail.

Further, without disassembling the pickers 52, the motor bracket 53, the stepping motor 54, the bracket 55, the lead screw 56, and the fixing member 57 from the rail 51, the rail ASSY 5 can be assembled to and disassembled from the chassis. Accordingly, positional adjustment of members to be fixed to the rail, which is accompanied when the rail is assembled and disassembled, is not required.

While the present invention has been described in detail and pictorially in the accompanying drawings, the present invention is not limited to such detail but covers various obvious modifications and equivalent arrangements, which fall within the purview of the appended claims.

What is claimed is:

1. An ODD archive apparatus to which a plurality of optical disk media are mounted, the ODD archive apparatus comprising:
a cartridge unit accommodating the plurality of optical disk media therein;
an optical disk drive for reading/writing data from/to the plurality of optical disk media;
a rail assembly for carrying the plurality of optical disk media; and
a chassis accommodating the cartridge unit, the optical disk drive, and the rail assembly therein,
the rail assembly including:
a carrying unit for holding and carrying one of the plurality of optical disk media;
a rail for guiding movement of the carrying unit; and
a motor for moving the carrying unit, the rail assembly having both end portions fixed to the chassis.

2. The ODD archive apparatus according to claim 1,
wherein the chassis is a box-like member formed by a chassis base, a front panel extending substantially upright from the chassis base, and a rear panel assembly, and
wherein the rail assembly has one end portion fixed to the front panel, and another end portion fixed to the rear panel assembly.

3. The ODD archive apparatus according to claim 2, wherein the rail assembly includes, at a front end portion thereof, a protrusion to be engaged in a recess of the front panel.

4. The ODD archive apparatus according to claim 2,
wherein the rear panel assembly includes a pin protruding toward the front panel, and
wherein the rail assembly includes a hole to be engaged with the pin.

5. The ODD archive apparatus according to claim 4,
wherein the rail assembly includes a threaded screw which is engaged with the carrying unit and causes the carrying unit to move by rotation of the motor,
wherein the threaded screw is held in the rail assembly by a first bearing provided on the front panel side and by a second bearing provided on the rear panel assembly side,
wherein the first bearing is fitted in the recess formed on a bottom surface side of the rail,
the second bearing is fixed to a bracket fixed to a rear end portion of the rail, and
wherein the hole is formed in the bracket.
